(19) United States
(12) Patent Application Publication
(10) Pub. No.: US 2026/0079604 A1
(43) Pub. Date: Mar. 19, 2026

(54) METAL MESH STRUCTURE

(71) Applicant: Henghao Technology Co., Ltd., Hsin-chu County (TW)

(72) Inventors: Hsueh-Chih Wu, Taichung City (TW); Chi-Wen Lo, Taichung City (TW); Shan-Chen Huang, Taoyuan City (TW); Tzu-Jung Chiang, Taoyuan City (TW); Che-Wei Yen, Taoyuan City (TW)

(73) Assignee: Henghao Technology Co., Ltd., Hsin-chu County (TW)

(21) Appl. No.: 19/307,056

(22) Filed: Aug. 22, 2025

(30) Foreign Application Priority Data
Sep. 16, 2024 (TW) 113135034

(51) Int. Cl. G06F 3/044

(52) U.S. Cl. CPC G06F 3/0446; G06F 3/0445; G06F 2203/04112

(57) ABSTRACT

The present invention provides a metal mesh structure including unit pattern columns, with unit patterns repeatedly arranged in a first direction, arranged in a second direction. Each of the unit patterns includes a first frame-shaped pattern and a second frame-shaped pattern, which respectively include a first side, a second side, a third side, and a fourth side, connected to form a ∧-shaped pattern. The first side of the first frame-shaped pattern overlaps the fourth side of the second frame-shaped pattern, the second side of the first frame-shaped pattern meets the fourth side of the second frame-shaped pattern at a node, and the fourth side of the first frame-shaped pattern connects with the first side of the second frame-shaped pattern and shares a same vertex. At the node, two angles, which are supplementary angles to each other, are formed on two sides of the second side of the first frame-shaped pattern.

### BACKGROUND OF THE INVENTION

### 1. Field of the Invention

The present invention relates to a metal mesh structure and particularly to a metal mesh structure applied to a touch panel.

### 2. Description of the Prior Art

In recent years, the metal mesh structure adopted in the sensing electrode of the touch panel has been developed. Common metal mesh structure is formed by a checkerboard pattern composed of multiple identical rhombic grids, wherein an X pattern, which is four line segments with one node, is formed at the node where the grid lines intersect, and at least two of the angles formed thereat are smaller, such as being the acute angles. Hence, in the manufacturing process, an undesired widened pattern is prone to be formed due to the diffraction of light, such that the area of the formed metal mesh structure in practice is greater than the designed area. When combined with the display panel, a larger portion of the display area will be covered by the widened pattern to cause insufficient light mixing, which may form grey spots and affect the user experience. In addition to the above, when the rhombic grids are combined with display panel having periodically placed pixels, it is easily to produce visible moiré patterns, which will affect the display quality. Consequently, how to reduce the effect of the metal mesh structure on brightness and how to reduce the interference of moiré patterns are the technical challenges that the industry needs to address.

### SUMMARY OF THE INVENTION

The technical problem that the present invention intends to solve is to reduce the grey spots effect produced by the metal mesh structure and the interference of moiré patterns.

In order to solve the aforementioned technical problem, the present invention provides a metal mesh structure including a plurality of unit pattern columns, wherein each of the unit pattern columns includes a plurality of unit patterns repeatedly arranged in a first direction, the unit pattern columns are arranged in a second direction to form the metal mesh structure, and the second direction is not parallel to the first direction. In addition, each of the unit patterns includes a first frame-shaped pattern and a second frame-shaped pattern connected to and arranged next to each other to form a ∧-shaped pattern, wherein each of the first frame-shaped pattern and the second frame-shaped pattern includes a first side, a second side, a third side, and a fourth side, the first side is connected to the second side and the fourth side and is opposite to the third side, and a length of the first side and a length of the third side are both less than a length of the second side and a length of the fourth side. The first side of the first frame-shaped pattern overlaps a portion of the fourth side of the second frame-shaped pattern, the second side of the first frame-shaped pattern meets the fourth side of the second frame-shaped pattern at a node, and the fourth side of the first frame-shaped pattern connects with the first side of the second frame-shaped pattern and shares a same vertex with the first side of the second frame-shaped pattern. Besides, at the node, the second side of the first frame-shaped pattern meets the fourth side of the second frame-shaped pattern to form two angles on two sides of the second side of the first frame-shaped pattern, and the two angles are supplementary angles to each other.

The present invention utilizes the ∧-shaped unit patterns arranged to form the unit pattern column, such that the node region of the metal mesh structure is a design of three line segments with one node, and that is, having a T-shaped pattern, which reduces the effect of diffraction of light and consequently improves the grey spots problem in the prior art. Apart from the above, the design of the metal mesh structure of the present invention may also effectively improve the problem of moiré patterns.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 schematically illustrates a top view of a metal mesh structure according to a first embodiment of the present invention.

FIG. 2 schematically illustrates a top view of a unit pattern of the metal mesh structure according to the first embodiment of the present invention.

FIG. 3 schematically illustrates a top view of a touch panel according to the present invention.

FIG. 4 schematically illustrates a top view of a metal mesh structure according to a modified embodiment of the first embodiment of the present invention.

FIG. 5 schematically illustrates a top view of a unit pattern of the metal mesh structure according to the modified embodiment of the first embodiment of the present invention.

FIG. 6 schematically illustrates a top view of a metal mesh structure according to a comparison example.

FIG. 7 schematically illustrates a top view of a metal mesh structure according to a second embodiment of the present invention.

FIG. 8 schematically illustrates a top view of a unit pattern of the metal mesh structure according to the second embodiment of the present invention.

FIG. 9 schematically illustrates a top view of a metal mesh structure according to a third embodiment of the present invention.

### DETAILED DESCRIPTION

The contents of the present invention will be described in detail with reference to specific embodiments and drawings. It is noted that, for purposes of illustrative clarity and ease of understanding by the readers, the following drawings in the present invention may be a simplified illustrations, and the elements therein may not be drawn to scale. The numbers and sizes of the elements in the drawings are merely illustrative and are not intended to limit the scope of the present disclosure.

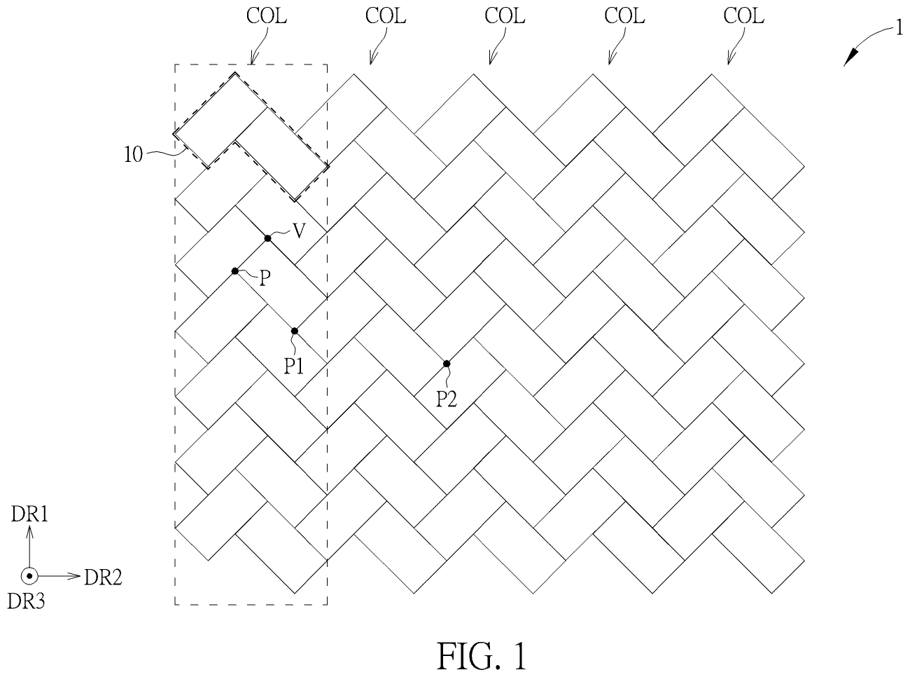

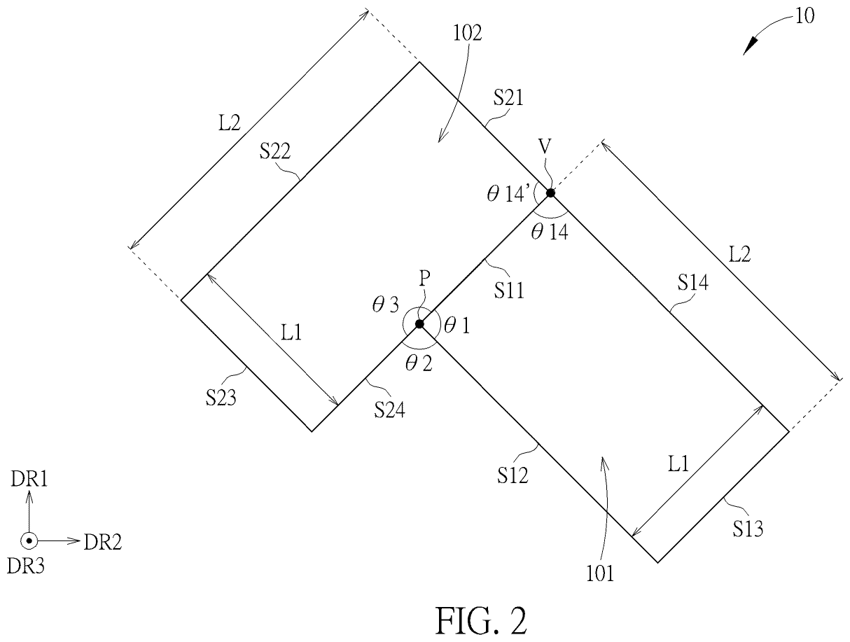

Refer to FIG. 1 and FIG. 2. FIG. 1 schematically illustrates a top view of a metal mesh structure according to a first embodiment of the present invention, and FIG. 2 schematically illustrates a top view of a unit pattern of the metal mesh structure according to the first embodiment of the present invention. As shown in FIG. 1, a metal mesh structure 1 provided by the first embodiment of the present invention includes a plurality of unit patterns 10. The unit patterns 10 are arranged repeatedly along a first direction DR1 to form a plurality of unit pattern columns COL. The plurality of unit pattern columns COL are arranged side by side along a second direction DR2 to form the metal mesh structure 1, wherein the first direction DR1 is not parallel to the second direction DR2, and the first direction DR1 and the second direction DR2 are perpendicular to the normal direction or a third direction DR3 parallel to the top view direction. In this embodiment, the first direction DR1 is perpendicular to the second direction DR2, but not limited thereto.

As shown in FIG. 2, one single unit pattern 10 includes a first frame-shaped pattern 101 and a second frame-shaped pattern 102 connected to and arranged next to each other to form a ∧-shape pattern, wherein the first frame-shaped pattern 101 and the second frame-shaped pattern 102 are respectively a quadrilateral or a quadrilateral-like shape, and the fourth sides of the quadrilateral are not all equal in length. Each of the first frame-shaped pattern 101 and the second frame-shaped pattern 102 includes a first side, a second side, a third side, and a fourth side, wherein the first side is connected to the second side and the fourth side and is opposite to the third side, and a length of the first side and a length of the third side are both less than a length of the second side and a length of the fourth side. Taking the first frame-shaped pattern 101 as an example, it includes a first side S11, a second side S12, a third side S13, and a fourth side S14, wherein two ends of the first side S11 are connected to the second side S12 and the fourth side S14, and the first side S11 is opposite to the third side S13. The first frame-shaped pattern 101 of this embodiment is a parallelogram, wherein opposite sides have identical lengths, but lengths of four sides are not completely equal to each other. For example, the first side S11 and the third side S13 have an identical length L1, the second side S12 and the fourth side S14 have an identical length L2, and the length L1 is less than the length L2. In this embodiment, the first frame-shaped pattern 101 may be a rectangle, and the four interior angles thereof may all be 90 degrees, but not limited thereto. Similarly, the second frame-shaped pattern 102 includes a first side S21, a second side S22, a third side S23, and a fourth side S24, wherein two ends of the first side S21 are connected to the second side S22 and the fourth side S24, the first side S21 is opposite to the third side S23, and the length L1 of the first side S21 and the length L1 of the third side S23 are both less than the length L2 of the second side S22 and the length L2 of the fourth side S24. The second frame-shaped pattern 102 of this embodiment may also be a rectangle, but not limited thereto. In the unit pattern 10, the first side S11 of the first frame-shaped pattern 101 overlaps a portion of the fourth side S24 of the second frame-shaped pattern 102, the second side S12 of the first frame-shaped pattern 101 meets the fourth side S24 of the second frame-shaped pattern 102 at a node P, and the fourth side S14 of the first frame-shaped pattern 101 connects with the first side S21 of the second frame-shaped pattern 102 and shares a same vertex V with the first side S21 of the second frame-shaped pattern 102. In this embodiment, the fourth side S14 of the first frame-shaped pattern 101 and the first side S21 of the second frame-shaped pattern 102 may be collinear, and the two are connected to each other to form a straight line extending along a direction, but not limited thereto.

At the node P, the second side S12 of the first frame-shaped pattern 101 meets the fourth side S24 of the second frame-shaped pattern 102 to form an angle θ1 and an angle θ2 on two sides of the second side S12 of the first frame-shaped pattern 101, and the angle θ1 and the angle θ2 are supplementary angles to each other, i.e., θ1+θ2=180°. Consequently, an angle θ3 on the other side of the first frame-shaped pattern 101 is 180 degrees. In this embodiment, the angle ranges of the angle θ1 and the angle θ2 may, for example, be greater than or equal to 5 degrees and less than or equal to 175 degrees, i.e., 5°≤θ1≤175° and 5°≤θ2≤175°. In some embodiments, the range of the angle θ1 may be greater than or equal to 20 degrees and less than or equal to 160 degrees, preferably greater than or equal to 55 degrees and less than or equal to 125 degrees, and the angle θ2 is equal to 180 degrees minus the angle θ1. When the angle θ1 is within the aforementioned range, such as 55°≤θ1≤125°, light diffraction issues in the lithography process can be mitigated, thereby improving the effect of the lithography process at the node P. In this embodiment, the outline of the first frame-shaped pattern 101 and the outline of the second frame-shaped pattern 102 may both approximately be the rectangle with two short sides and two long sides, and hence, the angle θ1 and the angle θ2 are respectively be 90 degrees. Furthermore, the outline of the first frame-shaped pattern 101 and the outline of the second frame-shaped pattern 102 may be approximately the same, which means the two may have the identical shapes and sizes, but not limited thereto. Since the first frame-shaped pattern 101 is equal to the second frame-shaped pattern 102, the corresponding sides and interior angles are all the same between the two frame-shaped patterns. For example, an angle θ14 between the first side S11 and the fourth side S14 of the first frame-shaped pattern 101 is identical to an angle θ14′ between the first side S21 and the fourth side S24 of the second frame-shaped pattern 102.

In the present invention, the metal mesh structure 1 may, for example, be formed with metal fine wires including the aforementioned first sides S11, S21, the second sides S12, S22, the third sides S13, S23, and the fourth sides S14, S24 through the lithography process and the etching process, wherein the materials of the metal fine wires, for example, includes gold, silver, copper, aluminum, nickel, zinc, other suitable materials, or an alloy or a combination of the aforementioned materials, but not limited thereto. As shown in FIG. 1 and FIG. 2, the metal mesh structure 1 of the present invention has the unit patterns 10 with a shape of Greek letter “∧”, and the unit patterns 10 are arranged repeatedly in the first direction DR1 to form the unit pattern columns COL. As shown in FIG. 1, one unit pattern row COL has a “wheat ear” shaped pattern because it includes multiple repeatedly arranged ∧-shaped unit patterns 10. According to the above-mentioned designs of the present invention, the nodes formed at the intersection of the metals or where the metal wires meets in the metal mesh structure 1 each exhibit a T-shaped pattern having three line segments converging at a single node. In detail, for example, the node P of the unit pattern 10 is where the second side S12 of the first frame-shaped pattern 101 meets the fourth side S24 of the second frame-shaped pattern 102, and the node P possesses the T-shaped pattern having three line segments converging at one node. Furthermore, the formed vertex V where the fourth side S14 of the first frame-shaped pattern 101 meets the first side S21 of the second frame-shaped pattern 102 also exhibits the T-shaped pattern having three line segments with one node. As shown in FIG. 1, the intersections of the metal wires between the unit patterns 10 and/or the unit pattern columns COL all form the T-shaped patterns having three line segments with one node, such as the node P1 and the node P2, and others will not be elaborated redundantly. In contrast to the present invention, the metal mesh structure commonly seen in the prior art are composed of periodical rhombic grids, and their nodes formed at the intersections usually exhibit an X-shaped pattern (i.e., four line segments converging at a single one node), resulting in at least two of the formed angles being small, and therefore the metal mesh structure in the prior art has a flaw involving undesired widened areas around the acute angles of the nodes, for example, after the patterning process. However, as shown in FIG. 1, in the design of three line segments converging at one node for the metal mesh structure 1 of the present invention, the three included angles can be greater than the four angles in the X-shaped pattern in the prior art, at the T-shaped node (e.g., the node P, the node P1, the node P2, and the vertex V), the area of the node may consequently be less prone to undesired enlargement due to light diffraction during the patterning process. As a result, the final formed metal mesh structure 1 may more closely match the originally designed pattern, which reduces grey spots on the screen, ensures more uniform brightness across the entire screen, and enhances the display quality.

In addition, in this embodiment, the length L1 of the first side S11/S21 of the first frame-shaped pattern 101 and/or the second frame-shaped pattern 102 may, for example, range from 300 micrometers (μm) to 700 micrometers, and a ratio of the length L2 of the second side S12/S22 to the length L1 of the first side S11/S21 may be greater than 1 and less than or equal to 5, but not limited thereto. It is noted that if the ratio of the length L2 of the second side S12/S22 to the length L1 of the first side S11/S21 is too large, for example, greater than 5, it may cause the situation that one side is too long compared with the other side, which affects the electrical performance and increase the channel resistance. Furthermore, if the ratio of the length L2 to the length L1 is equal to 1, it indicates that the first frame-shaped pattern 101 and/or the second frame-shaped pattern 102 is a square or a rhombus. Accordingly, the metal mesh structure formed by the repeatedly arranged patterns will have X-shaped nodes, similar to the prior art, and therefore cannot solve the problem of the undesired widened area of the node due to light diffraction.

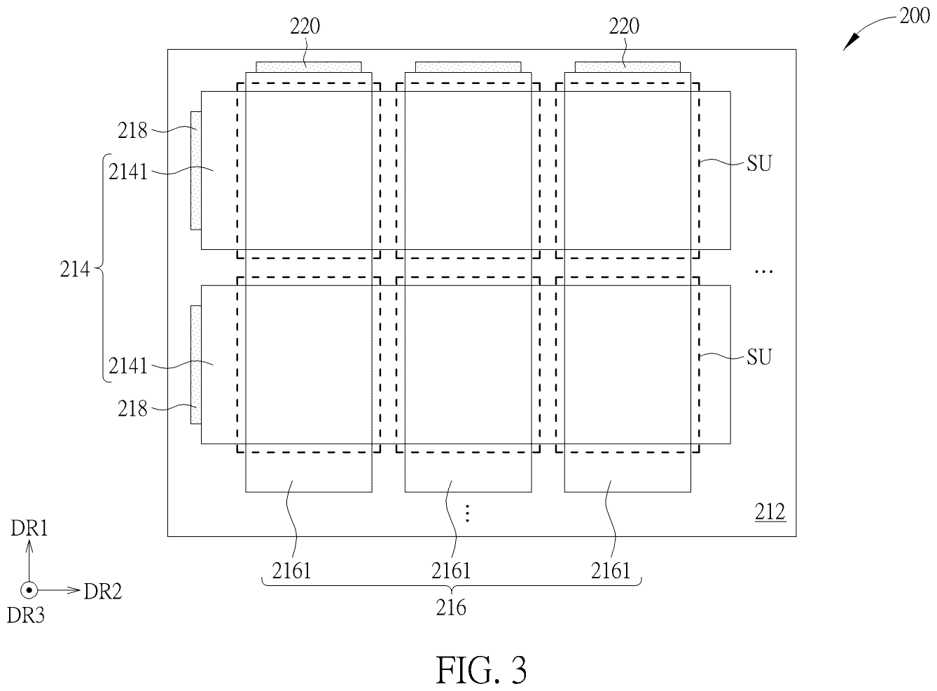

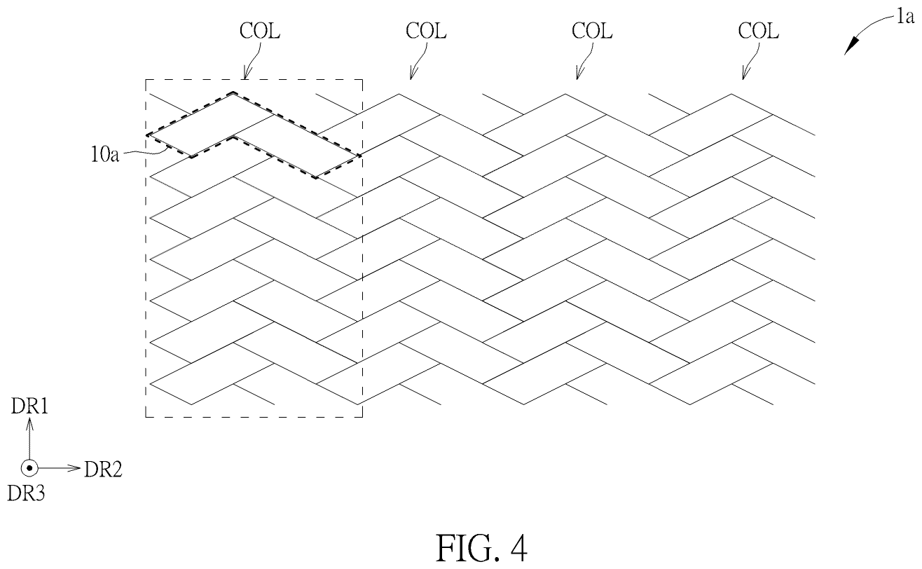

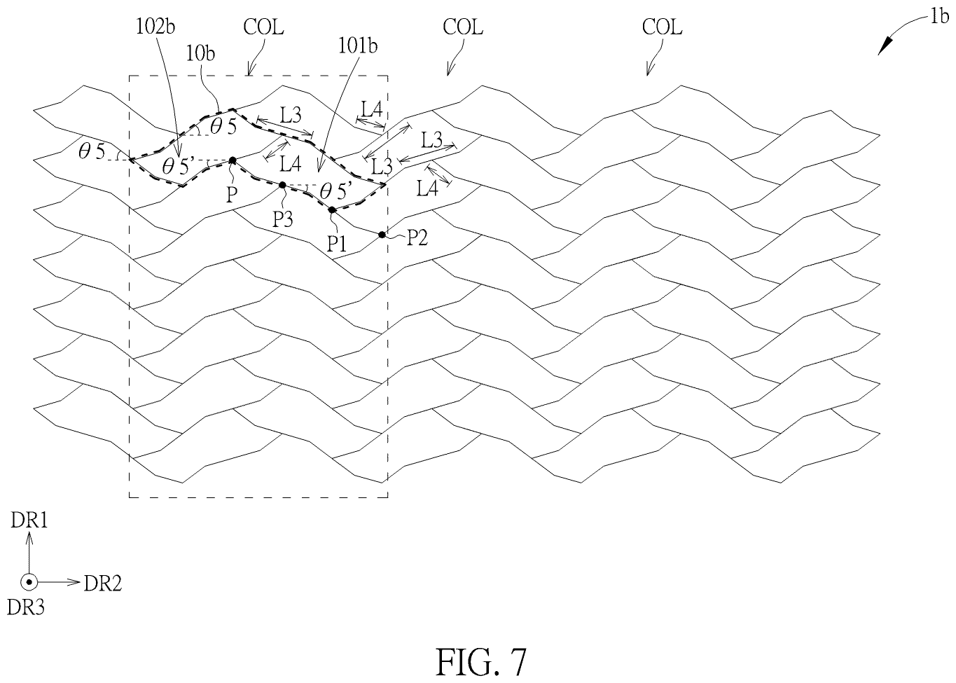

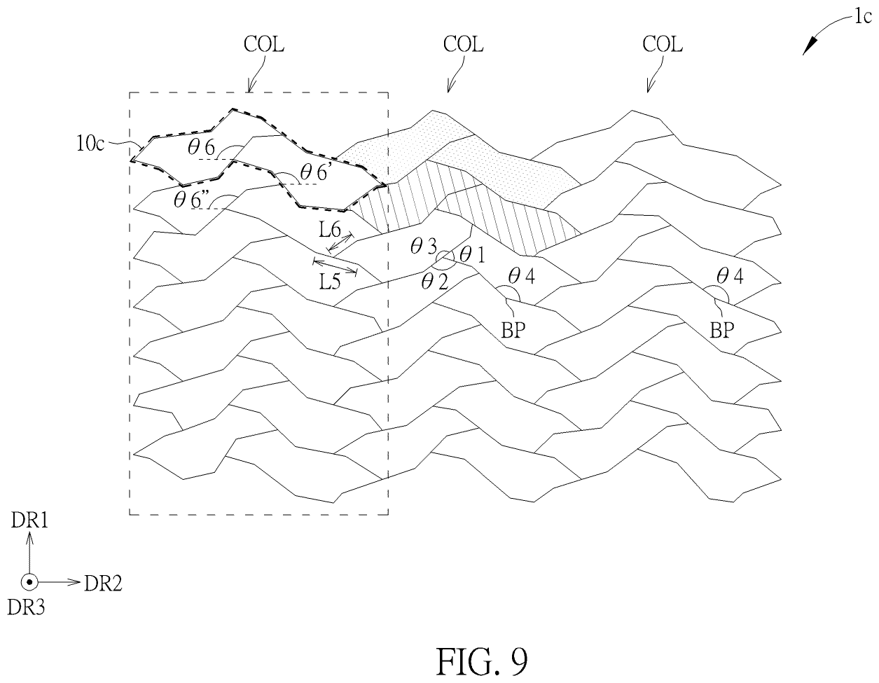

The metal mesh structure 1 of the present invention may be applied to a touch panel to serve as the touch electrode(s). Refer to FIG. 3. FIG. 3 schematically illustrates a top view of a touch panel to which the metal mesh structure of the present invention is applied. As shown in FIG. 3, a touch panel 200 provided by this embodiment includes a substrate 212, a first metal layer 214, and a second metal layer 216, wherein the first metal layer 214 and the second metal layer 216 are disposed on the substrate 212, and the second metal layer 216 is electrically isolated from the first metal layer 214. For example, in the third direction DR3, an insulation layer or a substrate (not shown in the figure) is disposed between the second metal layer 216 and the first metal layer 214. The first metal layer 214 includes a plurality of first touch electrodes 2141 extending along the first direction DR1, and the second metal layer 216 includes a plurality of second touch electrodes 2161 extending along the second direction DR2, wherein each of the first touch electrodes 2141 is formed by the metal mesh structure 1 of the present invention, and each of the second touch electrodes 2161 is also formed by the metal mesh structure 1 of the present invention. For example, the outlines of the first touch electrodes 2141 and the second touch electrodes 2161 may individually be in a strip shape or any other suitable shape, but not limited thereto. In addition, in the top view of the touch panel 200 (i.e., viewing in the third direction DR3), the first touch electrodes 2141 cross with the second touch electrodes 2161, which produces coupling capacitance to form a plurality of sensing units SU for detecting the position of an touch object. Each of the sensing units SU may, for example, be formed by one first touch electrode 2141 and one second touch electrode 2161 crossing with each other. For example, the first touch electrodes 2141 and the second touch electrodes 2161 may respectively serve as driving electrodes for transmitting driving signals and sensing electrodes for receiving sensing signals in the touch panel 200, or vice versa. To clearly illustrate the arrangement structure of the first touch electrodes 2141 and the second touch electrodes 2161, FIG. 3 illustrates only the outlines of the first touch electrodes 2141 and the second touch electrodes 2161, while omitting the detailed patterns of the metal mesh structure. The specific metal mesh structure may be referred to FIG. 1, as well as the embodiments shown in FIG. 4, FIG. 7, and FIG. 9. Furthermore, the touch panel to which the metal mesh structure of the present invention can be applied is not limited to the example shown in FIG. 3. The metal mesh structure of the present invention may be applied to any panel that includes a metal mesh conductive layer, serving as its conductive electrodes, touch electrodes, and/or conductive wires. The touch panel may include one layer or multiple layers of metal mesh conductive layers, and the touch electrodes may be of a mutual-capacitance type or a self-capacitance type, but the present invention is not limited to the above-mentioned contents.

In addition, as shown in FIG. 3, the touch panel 200 may optionally include a plurality of first connecting electrodes 218 and a plurality of second connecting electrodes 220, wherein the first connecting electrodes 218 may be respectively disposed and connected to one end or two ends of the first touch electrode 2141 to electrically connect the first touch electrode 2141 to a bonding pad or a control element, and the second connecting electrodes 220 may be respectively disposed and connected to one end or two ends of the second touch electrodes 2161 to electrically connect the second touch electrode 2161 to a bonding pad or a control element. The touch panel 200 may further optionally include a plurality of touch signal lines (not shown in the figure), which, for example, are respectively electrically connected to the first connecting electrodes 218 and the second connecting electrodes 220 for transmitting the touch signals. In a modified embodiment, the touch panel 200 may not include the connecting electrodes, and the touch signal lines may be directly connected to the first touch electrodes 2141 and the second touch electrodes 2161.

Consequently, referring to FIG. 1 and FIG. 3, the metal mesh structure 1 of the present invention may be disposed on a substrate, such as the substrate 212 shown in FIG. 3 or any other substrate not shown in the figures, to form the first touch electrodes 2141 or the second touch electrodes 2161. In the formation of the metal mesh structure 1, the metal fine wires may be formed through the aforementioned lithography process and the etching process to form the unit patterns 10 and the unit pattern columns COL, and the opening direction of the ∧-shaped unit pattern 10 may be adjusted according to arranging requirements of the first connecting electrodes 218 and/or the second connecting electrodes 220 of the touch panel 200. The substrate 212 may include transparent organic substrate materials or glass materials, wherein the transparent organic substrate materials, for example, include polyethylene terephthalate (PET), cyclo-olefin polymers (COP), colorless polyimide (CPI), polymethyl methacrylate (PMMA), polycarbonate (PC), thermoplastic polyurethane (TPU), other suitable materials, or a combination of the above-mentioned materials, and the glass materials, for example, include calcium sodium glass, aluminosilicate glass, or other suitable glass materials, but not limited thereto. After being integrated with a display panel, the touch panel 200 adopting the metal mesh structure 1 of the present invention can reduce small grey spots on the screen of the end product, such that the brightness of the whole screen of the end product may be more uniform, and the display quality is enhanced.

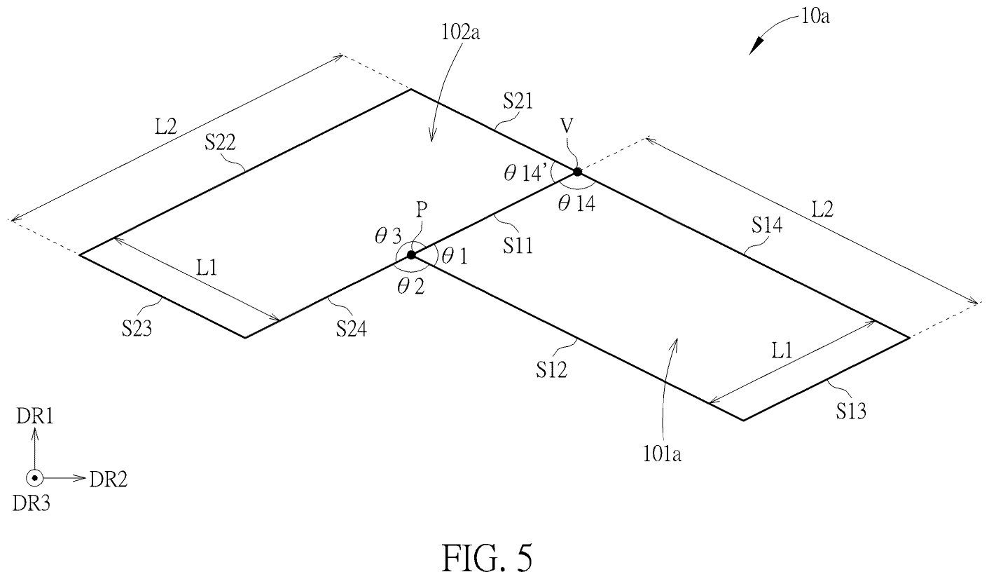

Refer to FIG. 4 and FIG. 5, wherein FIG. 4 schematically illustrates a top view of a metal mesh structure according to a modified embodiment of the first embodiment of the present invention, and FIG. 5 schematically illustrates a top view of a unit pattern of the metal mesh structure according to the modified embodiment of the first embodiment of the present invention. As shown in FIG. 4, the main difference between the metal mesh structure 1a of this modified embodiment and the metal mesh structure 1 of the first embodiment is that the shape of the unit pattern 10a of the metal mesh structure 1a is different from the shape of the unit pattern 10. As shown in FIG. 5, each of the outlines of the first frame-shaped pattern 101a and the second frame-shaped pattern 102a of the unit pattern 10a is a parallelogram, and none of the four interior angles of the parallelogram are right angles. It is noted that in this modified embodiment, the first frame-shaped pattern 101a and the second frame-shaped pattern 102a do not have identical shapes. Although the corresponding sides of the two frame-shaped patterns have the same lengths, their corresponding interior angles are supplementary to each other. For example, the lengths of the first side S11, the second side S12, the third side S13, and the fourth side S14 of the first frame-shaped pattern 101a are respectively the same as the lengths of the first side S21, the second side S22, the third side S23, and the fourth side S24 of the second frame-shaped pattern 102a; however, the angle θ14 between the first side S11 and the fourth side S14 of the first frame-shaped pattern 101a is supplementary to the angle θ14′ between the first side S21 and the fourth side S24 of the second frame-shaped pattern 102a, i.e., θ14+θ14′=180°. Other aspects of the metal mesh structure 1a of this modified embodiment (such as its functional effects) and other aspects of the first frame-shaped pattern 101a and the second frame-shaped pattern 102a of the unit pattern 10a of this modified embodiment (such as the arrangement of side lengths in the patterns and the relative positions of the two frame-shaped patterns) may be referred to the aforementioned first embodiment, and they will not be elaborated redundantly herein.

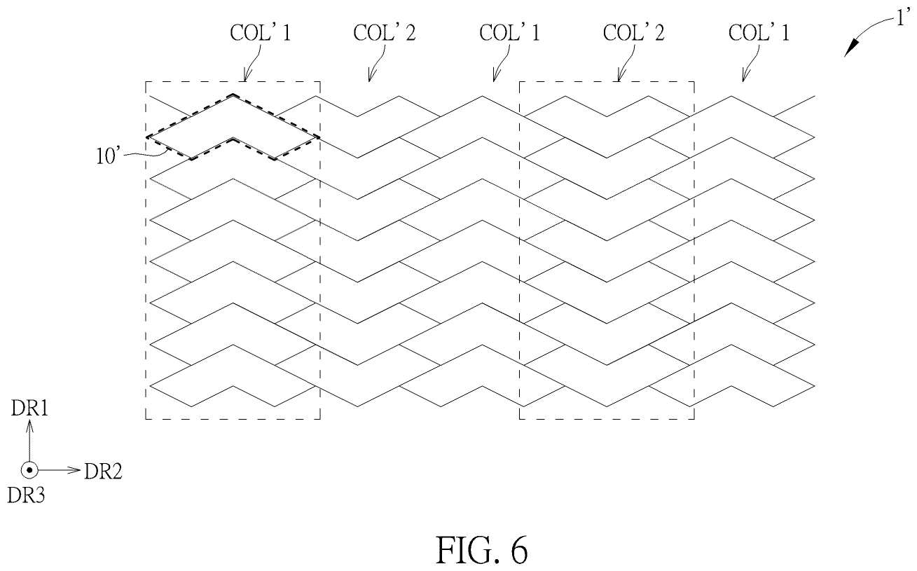

Refer to FIG. 6 and compare it with FIG. 1, wherein FIG. 6 schematically illustrates a top view of a metal mesh structure according to a comparison example. As shown in FIG. 6, this comparison example provides a metal mesh structure 1′ including plural “>” shaped unit patterns 10′, wherein some of the unit patterns 10′ whose pointy end faces upwards form a plurality of unit pattern columns COL′1 along the first direction DR1, other unit patterns 10′ whose pointy end faces downwards form a plurality of unit pattern columns COL′2 along the first direction DR1, and the plurality of unit pattern columns COL′1 and the plurality of unit pattern columns COL′2 are arranged in an alternating manner along the second direction DR2 to form the metal mesh structure 1′. The following content will compare the differences, advantages, and disadvantages between the metal mesh structure 1 of the present invention and the metal mesh structure 1′ of the comparison example. First, the short side, the long side, and the angle formed between the short side and the long side in the unit pattern 10′ of the metal mesh structure 1′ of this comparison example may be regarded as respectively corresponding to the first side S11, the second side S12, and the angle θ14′ of the unit pattern 10 of the present invention. The corresponding long sides and angles of the unit pattern 10′ are set to be respectively equal to those of the unit pattern 10 of the first embodiment of the present invention, thereby forming the metal mesh structure 1′ and the metal mesh structure 1 with identical mesh areas having the same overall lengths and widths and/or with identical outline areas. Next, the conductive paths of both structures are observed and compared. With the same mesh areas, the two have the same amount of conductive paths along the second direction DR2 while, along the first direction DR1, the metal mesh structure 1 of the present invention has more conductive paths than the metal mesh structure 1′ of the comparison example. Taking FIG. 6 as an example, the amount of conductive paths of the metal mesh structure 1 along the first direction DR1 has more than 30% than that of the metal mesh structure 1′ of the comparison example. That is, the metal mesh structure 1 of the present invention has an effect of lower channel resistance. Applying to the touch panels with the same size (or applying to the touch electrodes with the same size), the metal mesh structure 1 of the present invention has a better touch sensing sensitivity; or, with the same requirement for touch sensing sensitivity, comparing with the metal mesh structure 1′ of the comparison example, the metal mesh structure 1 of the present invention may support a touch panel with bigger size. In addition, regarding the design of the electrodes for the touch panel, the structure of the metal mesh structure 1 provided by the present invention allows greater flexibility and/or tolerance in aligning the direction with lower channel resistance (i.e., with more conductive paths) to serve as the extending directions of the first touch electrodes 2141 and/or the second touch electrodes 2161 according to the requirements in order to optimize the performance of touch sensing. In summary, the design of the metal mesh structure 1 of the present invention not only reduces the grey spots on the screen, makes the overall screen brightness more uniform, and enhances the display quality, but also has a better electrical effect, so as to increases the conductivity efficiency on a unit area.

The metal mesh structure of the present invention is not limited to the aforementioned embodiments. The following description continues to detail other embodiments. To simplify the description and to show the differences between different embodiments, identical components in each of the following embodiments are marked with identical symbols, and the identical features will not be redundantly described. In addition, the following embodiments may achieve the effect mentioned in the first embodiment.

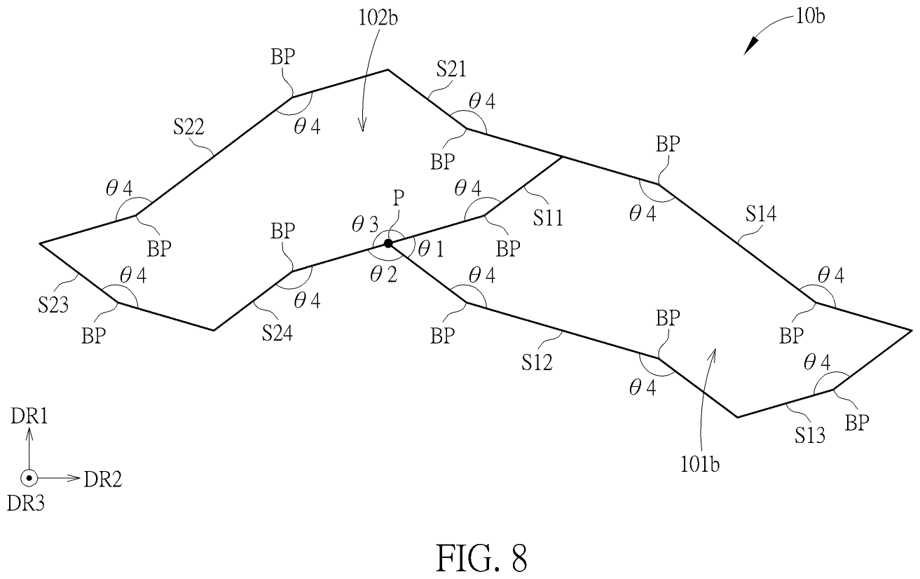

Refer to FIG. 7 and FIG. 8. FIG. 7 schematically illustrates a top view of a metal mesh structure according to a second embodiment of the present invention, and FIG. 8 schematically illustrates a top view of a unit pattern of the metal mesh structure according to the second embodiment of the present invention. As shown in FIG. 7, a main difference between the metal mesh structure 1b of this embodiment and the metal mesh structure 1 of the first embodiment is that the metal mesh structure 1b is composed of unit patterns 10b but not the unit patterns 10. As shown in FIG. 8, a main difference between the unit pattern 10b of this embodiment and the unit pattern 10 of the first embodiment is that in any one of the first frame-shaped pattern 101b and the second frame-shaped pattern 102b of each unit pattern 10b, at least one of the first sides S11, S21, the second sides S12, S22, the third sides S13, S23, and the fourth sides S14, S24 includes a bend BP, such that at least one side of the first frame-shaped pattern 101b and/or the second frame-shaped pattern 102b is not a straight line. For example, as shown in FIG. 8, in the first frame-shaped pattern 101b, the first side S11 has one bend BP, the second side S12 has two the bends BP, the third side S13 has one bend BP, and the fourth side S14 has two the bends BP, but not limited thereto. Under this condition, each of the bends BP may include an angle θ4, which may be referred as the bending angle, wherein the angle θ4 of any one of the bends BP may be identical to or different from the angle θ4 of another one of the bends BP. In this embodiment, the range of the angles θ4 may be greater than or equal to 90 degrees and less than or equal to 180 degrees, i.e., 90°≤θ4≤180°, but not limited thereto. It is noted that the bend BP of each side of the unit pattern 10b is not located at the junction where the different sides meet (e.g., not located at the node P, the node P1, the node P2, and the node P3). Consequently, in the second embodiment, the T-shaped pattern having three line segments converging at a single node is still formed at the junction where any one side of the first frame-shaped pattern 101b and the second frame-shaped pattern 102b meets another side, wherein the angle θ1 and the angle θ2 are supplementary to each other, and the angle θ3 is 180 degrees. In the embodiment shown in FIG. 8, the ranges of the angle θ1 and the angle θ2 are respectively (but not limited thereto) from 5 degrees to 175 degrees. Besides, as shown in FIG. 7 and FIG. 8, at each node, for example, at the node P1 and the node P2, the fourth side S14 of the first frame-shaped pattern 101b and the second side S22 of the second frame-shaped pattern 102b may respectively form an angle θ5 with respect to the horizontal line (parallel to the second direction DR2); for example, at the node P3 and the node P, the second side S12 of the first frame-shaped pattern 101b and the fourth side S24 of the second frame-shaped pattern 102b may respectively form an angle θ5′ with respect to the horizontal line, wherein the range of the angle θ5 may, for example, be greater than or equal to 20 degrees and less than or equal to 90 degrees, i.e., 20 ≤θ5≤90, and the range of the angle θ5′ may, for example, be greater than or equal to 20 degrees and less than or equal to 70 degrees, i.e., 20 ≤θ5′≤70, but not limited thereto. It is noted that the above-mentioned angles are to choose the acute angle formed between the described long side (the second side S12/S22 or the fourth side S14/S24) and the horizontal line so as to define as the angle θ5 and the angle θ5′. When the angle θ5 and the angle θ5′ fall into the aforementioned range, the inclined angle or extending direction of the long sides of the unit pattern 10b may be defined. Furthermore, there may be three bends BP around one T-shaped node, wherein two of the bends and the node lie on the same straight line, the distance between the two bends is a length L3, the other bend is not on that line, and the distance between the other bend and the node is a length L4, wherein the length L4 may, for example, range from 100 micrometers to 500 micrometers, and a ratio of the length L3 to the length L4 may be greater than or equal to 2 and less than or equal to 5, but not limited thereto.

In addition, each of the unit patterns 10b of the metal mesh structure 1b may all have the same shape, and therefore, the multiple unit pattern columns COL having “wheat ear” shaped pattern with the same pattern may be formed. In addition to the above, in the single unit pattern 10b, the first frame-shaped pattern 101b and the second frame-shaped pattern 102b may have the same or different shapes, and FIG. 8 takes the shape of the first frame-shaped pattern 101b is different from the shape of the second frame-shaped pattern 102b for example, but not limited thereto. Other properties of the metal mesh structure 1b of this embodiment and other properties of the first frame-shaped pattern 101b and the second frame-shaped pattern 102b of the unit pattern 10b of this embodiment (e.g., the effects it brings, the configurations and side length in the pattern, and the relative disposition position of the two frame-shaped patterns) may all be referred to the aforementioned embodiments, and they are not elaborated redundantly herein.

Refer to FIG. 9. FIG. 9 schematically illustrates a top view of a metal mesh structure according to a third embodiment of the present invention. A difference between the metal mesh structure 1c of this embodiment and the metal mesh structure 1b of the second embodiment is that the multiple unit patterns 10c of the metal mesh structure 1c are not exactly the same to each other, and that is, the outline of at least one of the unit patterns 10c is different from the outline of another one of the unit patterns 10c. For example, as shown in FIG. 9, the unit pattern 10c marked with dots and the unit pattern 10c marked with slashed lines do not share the same outlines. It is noted that in order to make the outline of any one of the unit patterns 10c not necessarily the same with the outline of another one of the unit patterns 10c, during designing the metal mesh structure 1c, it may adopt a random method to generate some values for the angles and may filter out a portion of the values that does not meet the rules of the metal mesh structure of the present invention, and then, the qualified values may be assigned as the angle θ1, the angle θ2, and the angle θ4, such that two of the unit patterns 10c with different outlines may be formed. For example, in FIG. 9, two bending angles labeled as the angle θ4 may have different values. Furthermore, in any one of the sides of the unit pattern 10c, distances between the bend BP and two ends of the side may be different or random. In this embodiment, since any one of the unit pattern 10c may be different from another one of the unit patterns 10c, which means the symmetry along each direction is lower compared with other embodiments, the metal mesh structure 1c includes the irregular unit patterns 10c, such that the whole structure presents an irregular design. In this way, when the metal mesh structure 1c including irregular unit patterns 10c is adopted in the touch panel and combined with the display panel, it is less likely to interfere with periodically placed pixels in the display panel to produce moiré patterns, such that the visual experience is enhanced, and uneasiness of the user is reduced.

In addition, at each node, the second side or the fourth side of the frame-shaped patterns may respectively form an angle with respect to the horizontal line, and FIG. 9 only labels the angle θ6, the angle θ6′, and the angle θ6″ at three nodes as an example, wherein the angle θ6, the angle θ6′, and the angle θ6″ are not all the same to each other, but the present invention is not limited thereto. The range of the angle (e.g., the angle θ6, the angle θ6′, and the angle θ6″) may, for example, be greater than or equal to 90 degrees and less than or equal to 160 degrees (i.e., 90 ≤θ6, θ6′, θ6″≤160) , but not limited thereto. Furthermore, as shown in FIG. 9, there are three bends around one T-shaped node, wherein two bends and the node are collinear. The distance between the two bends is a length L5, the other bend is not on that line, and the distance between the other bend and the node is a length L6, wherein the length L5 may, for example, range from 100 micrometers to 500 micrometers, and the length L6 may, for example, range from 100 micrometers to 500 micrometers, but not limited thereto. Other properties and effects of the metal mesh structure 1c of this embodiment may be identical or similar to the aforementioned embodiments, and they are not detailed redundantly herein.

In summary, in the metal mesh structure of the present invention, the metal mesh structure includes the unit pattern columns having “wheat ear”-shaped pattern composed of the ∧-shaped unit patterns. In the above-mentioned design, the patterns having three line segments with one node are formed at the nodes of the metal mesh, which means having the T-shaped pattern. The T-shaped node design may effectively inhibit the problem of increasing undesired node areas and producing grey spots due to diffraction of light at X-shaped nodes in the prior art. That is, the T-shaped node design of the present invention facilitates the node less likely to be widened but closer to the predetermined areas, such that the grey spots on the screen are reduced, the brightness of the whole screen is uniform, and the display quality is enhanced. Furthermore, the unit pattern columns having “wheat ear”-shaped pattern may be arranged side by side along a direction, this design may increase the conductive paths in a unit area, which effectively reduces the resistance and improves the electrical performance of the metal mesh. Besides, in an embodiment, since any two of the unit patterns may not be identical, such as the angles at the bends may not be the same, the metal mesh structure may not have symmetry, which means each of the unit patterns may present irregular design. Consequently, this design may further inhibit the problem of moiré patterns due to interference with the periodically placed pixels in the display panel in the prior art, which reduces uneasiness of the user and effectively improves the visual experience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A metal mesh structure, comprising:
a plurality of unit pattern columns, wherein each of the unit pattern columns comprises a plurality of unit patterns repeatedly arranged in a first direction, the unit pattern columns are arranged in a second direction to form the metal mesh structure, the second direction is not parallel to the first direction, and each of the unit patterns comprises:
a first frame-shaped pattern and a second frame-shaped pattern connected to and arranged next to each other to form a ∧-shaped pattern,
wherein each of the first frame-shaped pattern and the second frame-shaped pattern comprises a first side, a second side, a third side, and a fourth side, the first side is connected to the second side and the fourth side and is opposite to the third side, and a length of the first side and a length of the third side are both less than a length of the second side and a length of the fourth side,
wherein the first side of the first frame-shaped pattern overlaps a portion of the fourth side of the second frame-shaped pattern, the second side of the first frame-shaped pattern meets the fourth side of the second frame-shaped pattern at a node, and the fourth side of the first frame-shaped pattern connects with the first side of the second frame-shaped pattern and shares a same vertex with the first side of the second frame-shaped pattern,
wherein at the node, the second side of the first frame-shaped pattern meets the fourth side of the second frame-shaped pattern to form two angles on two sides of the second side of the first frame-shaped pattern, and the two angles are supplementary angles to each other.

2. The metal mesh structure according to claim 1, wherein the first frame-shaped patterns and the second frame-shaped patterns have identical shapes.

3. The metal mesh structure according to claim 1, wherein in each of the unit patterns, the first side and the fourth side of the first frame-shaped pattern have a first angle, the first side and the fourth side of the second frame-shaped pattern have a second angle, the first angle is different from the second angle, and the first angle is supplementary to the second angle.

4. The metal mesh structure according to claim 1, wherein the first frame-shaped pattern and the second frame-shaped pattern are parallelograms.

5. The metal mesh structure according to claim 1, wherein in any one of the first frame-shaped patterns and the second frame-shaped patterns, a length of the first side ranges from 300 micrometers to 700 micrometers, and a ratio of a length of the second side to the length of the first side is greater than 1 and less than or equal to 5.

6. The metal mesh structure according to claim 1, wherein in any one of the first frame-shaped pattern and the second frame-shaped pattern of each of the unit patterns, at least one of the first side, the second side, the third side, and the fourth side comprises a bend.

7. The metal mesh structure according to claim 6, wherein each of the unit patterns has a bending angle at the bend, and the bending angle is greater than or equal to 90 degrees and less than or equal to 180 degrees.

8. The metal mesh structure according to claim 7, wherein the bending angles of any two of the unit patterns have identical angles.

9. The metal mesh structure according to claim 7, wherein the bending angle of one of the unit patterns is different from the bending angle of another one of the unit patterns.

10. A touch panel, comprising:
a substrate; and
a metal layer disposed on the substrate, wherein the metal layer comprises:
a plurality of touch electrodes separated from each other, wherein each of the touch electrodes comprises the metal mesh structure according to claim 1.
